(19) United States
(12) Patent Application Publication
(10) Pub. No.: US 2022/0112346 A1
(43) Pub. Date: Apr. 14, 2022

(54) ETHYLENE VINYL ALCOHOL COPOLYMER/ETHYLENE ACRYLIC ACID COPOLYMER BLEND BARRIER COATINGS

(71) Applicant: Michelman, Inc., Cincinnati, OH (US)

(72) Inventors: Robin Cooper, Attert (BE); Guillaume Putod, Arlon (BE)

(73) Assignee: Michelman, Inc., Cincinnati, OH (US)

(21) Appl. No.: 17/424,223

(22) PCT Filed: Jan. 16, 2020
(86) PCT No.: PCT/US2020/013859

§ 371 Date: Jul. 20, 2021

Related U.S. Application Data
(60) Provisional application No. 62/796,750, filed on Jan. 25, 2019.

(51) Int. Cl. C08J 7/048; C08J 7/043; C08J 7/18; C08L 23/08; C08L 29/04; C09D 129/04; C08J 7/04

(52) U.S. Cl. CPC C08J 7/048; C08J 7/043; C08J 7/18; C08L 23/0869; C08L 29/04; C08J 2429/04; C08J 7/0423; C08L 2201/14; C08L 2203/16; C08J 2367/03; C09D 129/04

(57) ABSTRACT

A coated film with barrier properties can include a film comprising a layer selected from the group consisting of a polymer layer, vacuum applied coating, a printed layer, and a primer coating; an ethylene vinyl alcohol copolymer/ethylene acrylic acid copolymer blend (EVOH/EAA) barrier coating on the layer and comprising ethylene vinyl alcohol copolymer (EVOH) and ethylene acrylic acid copolymer (EAA) at a weight ratio of EVOH to EAA of 1.5:1 to about 6:1, wherein the EAA has an acrylic acid content of 10 wt % to 35 wt %; and wherein the coated film has percent reduction in oxygen transmission rate (23° C., 50% relative humidity) of 80% or greater relative to a same film without the EVOH/EAA barrier coating.

### BACKGROUND

The present disclosure relates to improving the barrier properties and water resistance of polymeric films.

Thermoplastic polymer films (e.g., polyolefin, polyamide, and polyester films) have excellent strength and transparency, which makes them particularly suitable as packaging materials for food, cosmetics, medicine, and the like. However, such films are relatively permeable to gases such as oxygen. During storage, gases can permeate the film and interact with the packaged contents, causing degradation.

Gas barrier coatings are used on polymeric substrates to provide a barrier in packaging to prevent degradation of the product. One known gas barrier coating is crystalline polyvinylidene chloride (PVDC). However, to achieve high gas barrier properties, the PVDC thickness should be greater than one micron. In practice, the PVDC is suspended in water and deposited as a coating on a film surface. Then, because PVDC decomposes when exposed to high temperatures, the drying process to drive off the water and leave a crystalline PVDC coating takes a significant amount of time and manufacturing facility footprint. Furthermore, a poisonous dioxin can be generated when burning films with PVDC coatings (e.g., in trash burning power plants), which can cause environmental and worker safety concerns.

Another polymeric gas barrier coating is ethylene vinyl alcohol copolymer (EVOH). EVOH has significantly lower oxygen permeability than PVDC in 0% relative humidity. However, EVOH is moisture sensitive. Accordingly, as the moisture levels increase the oxygen barrier properties are compromised. Further, EVOH is prone to shrinking when exposed to higher temperatures. Therefore, when EVOH is used in food packaging applications, the processing and storage conditions are important for maintaining suitable gas barrier properties and package integrity.

Another known gas barrier coating is a vacuum applied coating of metal or metal oxide. Such a coating typically comprises a thin layer of aluminum and/or aluminum oxide, which is applied to a substrate by vacuum deposition. Such a vacuum applied coating reduces the permeability of the polymeric film substrate to light, water, and oxygen. However, the vacuum applied coatings are costly to include in the film manufacturing process. The metal vacuum applied coatings are also opaque. Additionally, the vacuum applied coating can be easily damaged, which would negate the barrier properties. Further, the inclusion of metals and/or metal oxides can reduce the recyclability of the packaging.

### BRIEF DESCRIPTION OF THE DRAWINGS

The following figures are included to illustrate certain aspects of the embodiments, and should not be viewed as exclusive embodiments. The subject matter disclosed is capable of considerable modifications, alterations, combinations, and equivalents in form and function, as will occur to those skilled in the art and having the benefit of this disclosure.

FIGS. 1-11 are examples of films that include an ethylene vinyl alcohol copolymer/ethylene acrylic acid copolymer blend (EVOH/EAA) barrier coating.

FIG. 12 is a plot of the oxygen transmission rate (OTR) (cc/(m²·day)) as a function of (ethylene vinyl alcohol) EVOH weight percent in the dried coating.

FIG. 13 is a plot of the OTR (cc/(m²·day)) and water resistance as a function of EVOH weight percent in the dried coating.

FIG. 14 is a plot of the viscosity of EVOH/EAA barrier coating mixtures as a function of neutralization degree of EAA.

FIG. 15 is a plot of the OTR (cc/(m²·day)) of EVOH/EAA barrier coating as a function of neutralization degree of EAA in the EVOH/EAA barrier coating mixtures

FIG. 16 is a plot of the OTR (cc/(m²·day)) as a function of dry coat weight (g/cm²) of a EVOH/EAA barrier coating.

FIG. 17 is the OTR and water resistance data plotted from EVOH/SA combination barrier coatings.

FIG. 18 is the OTR and water resistance data plotted from PVOH/EAA combination barrier coatings.

FIG. 19 is the OTR and water resistance data plotted from EVOH/EVA combination barrier coatings.

### DETAILED DESCRIPTION

The present disclosure relates to improving the barrier properties and water resistance of polymeric films using an ethylene vinyl alcohol copolymer/ethylene acrylic acid copolymer blend (EVOH/EAA) barrier coating. Advantageously, the EVOH/EAA barrier coating can be a thin coating (e.g., about 1 micron thick or less) in a film and achieve about 80% or greater reduction in oxygen transmission rate (23° C., 0% relative humidity) relative to the film without the EVOH/EAA barrier coating. Because the EVOH/EAA barrier coating is so thin, the resultant packaging is thinner with good barrier properties. Additionally, the thinness of the EVOH/EAA barrier coating allows for the production of packaging that is about 95 wt % or greater of a single polymer, which makes recycling straightforward by known processes.

The EVOH/EAA barrier coatings described herein comprise ethylene vinyl alcohol copolymer (EVOH) as the major component and ethylene acrylic acid copolymer (EAA) as the minor component. Preferably, the EAA used in the coatings has a low acrylic acid content (e.g., 15 wt % to 25 wt %) so that it is hydrophobic but has enough acrylic acid units to blend with the EVOH. Without being limited by theory, it is believed that the hydrophobic EAA increases the water resistance of the barrier coating as compared to EVOH without EAA and reduces the oxygen transmission rate over a wider range of relative humidity levels. Further, it is believed that using a crosslinking agent to crosslink the EVOH and EAA polymer chains can further enhance the barrier properties and water resistance of the coating. Additionally, when cured by e-beam irradiation, the shrinkage of the EVOH/EAA coating and the underlying substrate may be reduced and water resistance increased.

Generally, an EVOH/EAA barrier coating mixture is applied to a layer of a polymeric film and dried to produce an EVOH/EAA barrier coating. The layer of the polymeric film can be a polymer layer, a vacuum applied coating (e.g., comprising a metal and/or metal oxide), a printed layer, or a primer coating. In some instances, the layer having the EVOH/EAA barrier coating thereon is an outer layer such that there is no further processing required for use of the polymeric layer. In some instances, the layer having the EVOH/EAA barrier coating thereon can then be further processed to produce the final polymeric film.

Viscosity can be used to characterize the molecular weight of polymers where higher viscosity generally indicates a higher molecular weight. EVOH suitable for use in the compositions and methods of the present disclosure can have viscosity (20° C., 4% solids in water pH 6 to 8) of about 1 cps to about 35 cps, or about 3 cps to about 30 cps.

EAA suitable for use in the compositions and methods of the present disclosure can have an acrylic acid content of about 10 wt % to about 35 wt %, or about 10 wt % to about 30 wt %, or about 15 wt % to about 20 wt %. Acrylic acid content can be measured by FTIR.

EAA suitable for use in the compositions and methods of the present disclosure can have a Mn of about 2,000 g/mol to about 180,000 g/mol, or about 5,000 g/mol to about 50,000 g/mol, or about 50,000 g/mol to about 150,000 g/mol, or about 75,000 g/mol to about 125,000 g/mol. Mw can be measured by gel permeation chromatography (GPC).

EAA suitable for use in the compositions and methods of the present disclosure can have a neutralization degree of about 40% to about 70%, or about 45% to about 65%, or about 50% to about 60%. Neutralization degree can be measured by titration with sodium hydroxide where fully neutralized is 100% neutralization degree.

When applying an EVOH/EAA barrier coating mixture, the viscosity should be at a moderate level (e.g., less than 1000 centipoise (cps) and preferably less than 500 cps) to provide an even coating while still being readily processible. A higher neutralization degree for the EAA can increase the viscosity of the EVOH/EAA barrier coating mixture, too high of a neutralization degree and the mixture can become unprocessible. A lower neutralization degree for the EAA can cause the mixture to not be viscous enough to provide ample thickness of barrier coating to provide suitable barrier properties and compromise the barrier properties. The amount of EAA and the neutralization degree of the EAA can both be altered to provide appropriate viscosities for the EVOH/EAA barrier coating mixture.

The weight ratio of the EVOH to EAA in the EVOH/EAA barrier coating mixture, and consequently the resultant EVOH/EAA barrier coating, can be about 1.5:1 to about 6:1, about 2:1 to about 5.5:1, or about 3:1 to about 5:1.

The EVOH/EAA barrier coating mixture can include about 5 wt % solids to about 15 wt % solids, or about 7 wt % solids to about 10 wt % solids with the balance being water.

Preferably, the EVOH/EAA barrier coating has an absence of polyvinyl alcohol (PVOH). As used herein, an absence of PVOH encompasses the presence of PVOH at or below contamination level of 0.05 wt % based on the weight of EVOH. That is, in some instances, EVOH raw material may include small amounts of PVOH contamination (e.g., less than about 0.1 wt %). Preferably, no additional PVOH is added to the EVOH/EAA barrier coating mixture, so the EVOH/EAA barrier coating and EVOH/EAA barrier coating mixture have a PVOH concentration of 0 wt % to 0.05 wt % based on the weight of EVOH, and more preferably 0 wt % based on the weight of EVOH.

Crosslinking agents can be included in the EVOH/EAA barrier coating mixture and EVOH/EAA barrier coating. Examples of crosslinking agents include, but are not limited to, urea formaldehyde, melamine formaldehyde, glyoxal, glutaraldehyde, zirconium oxide, zinc oxide, titanium lactate, and the like, and any combination thereof.

The weight ratio of the EVOH to the crosslinking agent (cumulatively if more than one crosslinking agent is used) in the EVOH/EAA barrier coating mixture, and consequently the resultant EVOH/EAA barrier coating, can be about 1:0.01 to about 1:0.1, or about 1:0.04 to about 1:0.1.

Optionally, the EVOH/EAA barrier coating mixture, and consequently the resultant EVOH/EAA barrier coating, can further include adhesion promoters. Examples of adhesion promoters suitable for use in the compositions and methods of the present disclosure include, but are not limited to, polyethyleneimine, polyurethane, polyacrylic acid, and any combination thereof.

The weight ratio of the EVOH/EAA to the adhesion promoters in the EVOH/EAA barrier coating mixture, and consequently the resultant EVOH/EAA barrier coating, can be about 1:0.001 to about 1:0.3, about 1:0.02 to about 1:0.1.

Optionally, the compositions can further include particulate additives having an aspect ratio of 2 or greater. As used herein, the term “aspect ratio” refers to the largest diameter of the particulate divided by the smallest diameter of the particulate. For example, a disc-shaped particle having a thickness of 1 micron and a diameter of 10 microns has an aspect ratio of 10.

Examples of particulate additives having an aspect ratio of 2 or greater suitable for use in the compositions and methods of the present disclosure include, but are not limited to, clay particulates, mica particulates, talc particulates, graphene, halloysite nanotubes (HNT), and the like, and any combination thereof.

The weight ratio of the EVOH/EAA to the particulate additives in the EVOH/EAA barrier coating mixture, and consequently the resultant EVOH/EAA barrier coating, can be about 1:0.01 to about 1:5, about 1:0.1 to about 1:3, about 1:0.5 to about 1:1, or about 1:1 to about 1:5.

Preparation of the EVOH/EAA barrier coating mixture can be by any method. For example, the components of the EVOH/EAA barrier coating mixture can all be added to water or alkali solution to neutralize the EAA and mixed for a suitable amount of time, optionally at an elevated temperature (e.g., up to about 100° C., or ambient temperature to about 100° C., or about 80° C. to about 100° C.) before applying the mixture. Alternatively, the components of the EVOH/EAA barrier coating mixture can all be added to water or alkali solution to neutralize the EAA sequentially and mixed between additions for a suitable amount of time, optionally at an elevated temperature (e.g., up to about 100° C.) before applying the mixture. Alternatively, the EVOH and EAA can be mixed into water and alkali solution, respectively, to obtain separate mixtures for a suitable amount of time, optionally at an elevated temperature (e.g., up to about 100° C.) before applying the mixture. Then, the two mixtures can be mixed together in the appropriate proportions with other components to produce the EVOH/EAA barrier coating mixture.

The EVOH/EAA barrier coating mixture can be applied to a layer of a polymeric film and dried to produce an EVOH/EAA barrier coating. Optionally, to enhance adhesion between layers, a corona treatment or similar treatment can be used to increase the hydrophilicity of the layer to which the EVOH/EAA barrier coating mixture is being applied.

Application of the EVOH/EAA barrier coating mixture can be by any suitable method including, but not limited to, gravure coating, reverse gravure coating, roll coating, wire rod coating, flexographic printing, spray coating, and the like. The coating composition is preferably applied such that upon drying, the coating forms a smooth, evenly distributed layer. Optionally, the EVOH/EAA barrier coating mixture can be applied on top of a dried or substantially dried EVOH/EAA barrier coating. This can be performed so that two or more applications of the EVOH/EAA barrier coating mixture are used to form the final EVOH/EAA-barrier coating. The EVOH/EAA barrier coating (applied in one or more passes) can have a thickness of less than about 1 micron, about 0.1 microns to about 1 micron, or about 0.3 microns to about 0.5 microns.

After the EVOH/EAA barrier coating mixture is applied, it may be dried by hot air, radiant heat, or any other suitable method that provides a clear, adherent coating. The drying may crosslink the polymers and crosslinker (when present). Optionally, the method can also include exposing the coating (before, after, or during drying) to electron beam (e-beam) radiation. E-beam radiation may preferably reduce the shrinkage of the EVOH/EAA barrier coating as compared to a high temperature crosslinking. Further, e-beam radiation may preferably be used for crosslinking when films include temperature sensitive layers.

The EVOH/EAA barrier coating mixture can be applied to any layer of a polymeric film including, but not limited to, a polymeric layer, a metal layer, a metal oxide layer, a printed coating (e.g., an ink coating that may or may not complete cover adjacent layers), or a primer coating.

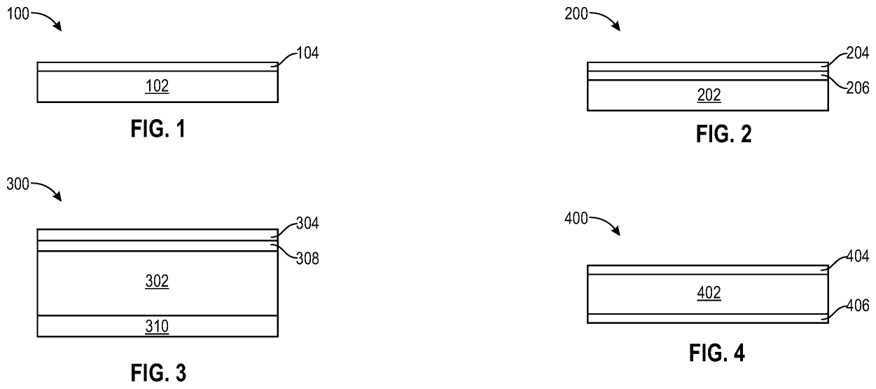

FIGS. 1-9 are examples of films that include an EVOH/EAA barrier coating.

In FIG. 1, the film 100 consists of a polymeric layer 102 having an EVOH/EAA barrier coating 104 on a surface of the polymeric layer 102. In this example, at least 95 wt % (preferably at least 98 wt %) of the film 100 consists of the polymeric layer 102. Accordingly, because so little weight of the film 100 is the EVOH/EAA barrier coating 104, standard recycling methods applicable to the composition of the polymeric layer 102 can be used to recycle the film 100.

Optionally, an overcoat layer can be added on top of the EVOH/EAA barrier coating 104 such that the EVOH/EAA barrier coating 104 is between the polymeric layer 102 and the overcoat layer.

In FIG. 2, the film 200 comprises a polymeric layer 202 with a vacuum applied coating 206 on a surface of the polymeric layer 202 and an EVOH/EAA barrier coating 204 on the vacuum applied coating 206 such that the vacuum applied coating 206 (comprising metal and/or metal oxide) is between the polymeric layer 202 and the EVOH/EAA barrier coating 204. Optionally, an overcoat layer can be added on top of the EVOH/EAA barrier coating 204 such that the EVOH/EAA barrier coating 204 is between the vacuum applied coating 206 and the overcoat layer.

In FIG. 3, the film 300 comprises, in order, an EVOH/EAA barrier coating 304, a primer coating 308, a core polymeric layer 302, and a heat-sealable polymeric layer 310. Optionally, the film could further include an adhesive coating (not illustrated) between the core polymeric layer and heat-sealable polymeric layer where the two-layer portion of the film is produced by lamination. Optionally, an overcoat layer can be added on top of the EVOH/EAA barrier coating 304 such that the EVOH/EAA barrier coating 304 is between the primer coating 308 and the overcoat layer.

In FIG. 4, the film 400 comprises a polymeric layer 402 between an EVOH/EAA barrier coating 404 and a vacuum applied coating 406. Optionally, an overcoat layer can be added on top of the EVOH/EAA barrier coating 404 such that the EVOH/EAA barrier coating 404 is between the polymeric layer 402 and the overcoat layer.

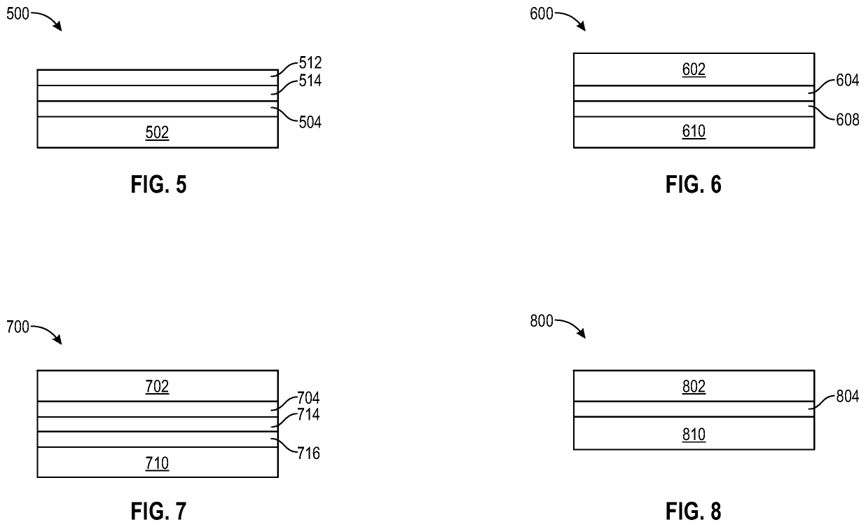

In FIG. 5, the film 500 comprises, in order, an overprint layer 512, a printed coating 514, an EVOH/EAA barrier coating 504, and a polymeric layer 502. In this example, the printed coating 514 is applied directly to the EVOH/EAA barrier coating 504. Then, the overprint layer 512 acts as a protective layer from the printed coating 514.

In FIG. 6, the film 600 comprises, in order, a polymeric layer 602, an EVOH/EAA barrier coating 604, a primer coating 608, and a heat-sealable polymeric layer 610.

In FIG. 7, the film 700 comprises, in order, a polymeric layer 702, an EVOH/EAA barrier coating 704, a printed coating 714, an adhesive coating 716, and a heat-sealable polymeric layer 710.

In FIG. 8, the film 800 comprises, in order, a polymeric layer 802, an EVOH/EAA barrier coating 804, and a heat-sealable polymeric layer 810. Optionally, a primer coating can be between the polymeric layer 802 and the EVOH/EAA barrier coating 804 and/or between the EVOH/EAA barrier coating 804 and the heat-sealable polymeric layer 810.

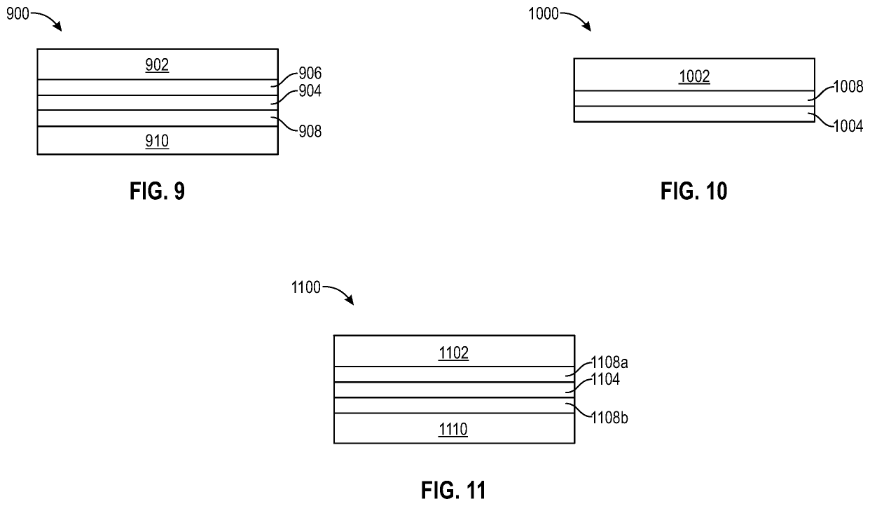

In FIG. 9, the film 900 comprises, in order, a polymeric layer 902, a vacuum applied coating 906, an EVOH/EAA barrier coating 904, a primer coating 908, and a heat-sealable polymeric layer 910.

In FIG. 10, the film 1000 comprises, in order, a polymeric layer 1002, a primer coating 1008, and an EVOH/EAA barrier coating 1004. Optionally, an overcoat layer can be added on top of the EVOH/EAA barrier coating 1004 such that the EVOH/EAA barrier coating 1004 is between the primer coating 1008 and the overcoat layer.

In FIG. 11, the film 1100 comprises, in order, a polymeric layer 1102, a first primer coating 1108a, an EVOH/EAA barrier coating 1104, a second primer coating 1108b, and a heat-sealable polymeric layer 1110.

The example films of FIGS. 3, 6-9, and 11 may be produced by laminating the polymeric layer or vacuum applied coating having the illustrated coatings thereon to the heat-sealable polymeric layer. Such films may be referred to as laminate films in the art.

When a film according to any of the foregoing examples is used, the food can be in contact with either side of the film. That is, EVOH/EAA is acceptable to be in contact with food, so the packaging can be designed with the EVOH/EAA barrier coating in contact with the food, in contact with the surroundings, or between other layers.

Examples of polymers suitable for use in polymeric layers include, but are not limited to, polylactic acid (PLA), polyethylene terephthalate (PET), biaxially oriented polyethylene terephthalate (BOPET), oriented polypropylene (OPP), biaxially oriented polypropylene (BOPP), cast polypropylene (CPP), polyethylene (PE), polypropylene (PP), biaxially oriented polyamide (BOPA), and any combination thereof.

Examples of metals and metal oxides suitable for use in vacuum applied coatings include, but are not limited to, aluminum, aluminum oxide, silicon oxide, silicon oxynitride, magnesium oxide, tin oxide, and any combination thereof.

Examples of materials suitable for use in primer coatings include, but are not limited to, polyethyleneimine, polyurethane, and a mixture of polyurethane and EAA. When used, the primer coating is typically applied to a polymeric layer or heat-sealable layer (corona treated or not) and allowed to dry before applying the EVOH/EAA barrier coating mixture. The primer coating is typically less than 10 microns thick and helps the barrier coating stick to the polymeric film or heat-sealable layer.

Examples of materials suitable for use in overcoat layers include, but are not limited to, styrene acrylics, acrylics, polyesters, EAA, polyurethane, PVOH, and any combination thereof.

The oxygen and water vapor barrier properties of the film are dependent on the various layers of the film. That is, the EVOH/EAA barrier coating of the present disclosure improves the barrier properties of a film as compared to the same film without the EVOH/EAA barrier coating.

The oxygen barrier properties of the film having the EVOH/EAA barrier coating can be reported as a percent reduction in oxygen transmission rate relative to the oxygen transmission rate of the reference (i.e., the same film without the EVOH/EAA barrier coating) (OTR_{ref}) per Equation 1, where (OTR_{EVOH/EAA}) is the oxygen transmission rate of the film having the EVOH/EAA barrier coating. OTR_{ref} and OTR_{EVOH/EAA} should be measured under the same temperature and relative humidity.

$$\frac{O T {R}_{r e f} - O T {R}_{EVOH / EAA}}{O T {R}_{r e f}} * 100 = \% reduction in OTR \qquad Eq . 1$$

The oxygen transmission rate can be measured according to ASTM D3985-17.

At 23° C. and 0% relative humidity, the percent reduction in OTR can be about 50% or greater, about 75% to about 99.9%, about 85% to about 99.9%, or about 90% to about 99.9%.

At 23° C. and 50% relative humidity, the percent reduction in OTR can be about 80% or greater, about 80% to about 99.9%, about 85% to about 99.9%, about 90% to about 99.9%, or about 95% to about 99.9%.

At 23° C. and 90% relative humidity, the percent reduction in OTR can be about 60% or greater, about 60% to about 99.9%, about 70% to about 99.9%, about 80% to about 99.9%, about 90% to about 99.9%, or about 95% to about 99.9%.

The water vapor barrier properties of the film having the EVOH/EAA barrier coating can be reported as a percent reduction in water vapor transmission rate relative to the water vapor transmission rate of the reference (i.e., the same film without the EVOH/EAA barrier coating) (WVTR_{ref}) per Equation 2, where (WVTR_{EVOH/EAA}) is the oxygen transmission rate of the film having the EVOH/EAA barrier coating. WVTR_{ref} and WVTR_{EVOH/EAA} should be measured under the same temperature and relative humidity.

$$\frac{{WVTR}_{r e f} - {WVTR}_{E V O H / E A A}}{{WVTR}_{r e f}} * 100 = \% reduction in WVTR \qquad Eq . 2$$

The water vapor transmission rate can be measured according to ASTM F1249-13.

At 38° C. and 90% relative humidity, the percent reduction in WVTR can be about 10% or greater, about 10% to about 99.9%, about 25% to about 99.9%, or about 50% to about 99.9%.

Water resistance is a measure of how well a coating maintains its integrity when exposed to liquid water. For various packaging applications, it is important that the EVOH/EAA barrier coating can maintain its integrity when exposed to water.

Water resistance is measured according to the following procedure:
A mixture of 1 wt % of eosin in water is prepared.
The eosin mixture is applied to a dried EVOH/EAA barrier coating and allowed to dry for 1 minute at 105° C. In the coating and drying process the eosin bonds to the EVOH in the barrier coating to produce a dyed EVOH/EAA barrier coating.
A water droplet is placed on three locations on the dyed EVOH/EAA barrier coating.
After 1 minute at 23° C. and 50% relative humidity, a first of the three water droplets is removed from the dyed EVOH/EAA barrier coating by first wicking away the water droplet with a paper tissue and then gently wiping the residual water away with the tissue.
After 2 minutes at 23° C. and 50% relative humidity, a second of the three water droplets is removed from the dyed EVOH/EAA barrier coating same as described for the 1-minute droplet.
After 5 minutes at 23° C. and 50% relative humidity, a third of the three water droplets is removed from the dyed EVOH/EAA barrier coating same as described for the 1-minute droplet.
The condition of the dyed EVOH/EAA barrier coating is then observed and tested to classify the water resistance of the EVOH/EAA barrier coating according to the following scale. The eosin dyes the barrier coating a pinkish-red color, so integrity of the dyed EVOH/EAA barrier coating can be observed. Using a white background (like a tissue or piece of paper) behind the film assists with determining a degree of degradation.
   5: No change to the dyed EVOH/EAA barrier coating observed for the 1-minute, 2-minute, and 5-minute droplets.
   4: No change to the dyed EVOH/EAA barrier coating observed for the 1-minute and 2-minute droplets. Degradation of the dyed EVOH/EAA barrier coating for the 5-minute droplet is observed such that the dyed EVOH/EAA barrier coating appears mostly intact but there are visible boarders from where the droplet was.
   3: Degradation of the dyed EVOH/EAA barrier coating for the 5-minute droplet is observed such that no more than 10% of the coating appears to be gone. For example, using a white background behind the film, dye is not observed over no more than 10% of the surface in contact with the 5-minute droplet.
   2: Degradation of the dyed EVOH/EAA barrier coating for the 5-minute droplet is observed such that more than 10% to 30% of the coating appears to be gone, degradation of the dyed EVOH/EAA barrier coating for the 2-minute droplet is observed, and degradation of the dyed EVOH/EAA barrier coating for the 1-minute droplet is not observed or is mostly intact but there are visible boarders from where the droplet was. For example, using a white background behind the film, dye is not observed over more than 10% to 30% of the surface in contact with the 5-minute droplet.
   1: Any degradation more than 2.

The water resistance of the EVOH/EAA barrier coating described herein can be about 3 to about 5, or about 4 to about 5.

The films described herein that include an EVOH/EAA barrier coating can be used in a variety of packaging applications including, but not limited to, food packaging, beverage packaging, pharmaceutical packaging, dietary supplement packaging, and the like.

### Example Embodiments

A nonlimiting example embodiment is a coated film comprising: a film comprising a layer selected from the group consisting of a polymer layer, vacuum applied coating, a printed layer, and a primer coating; an ethylene vinyl alcohol copolymer/ethylene acrylic acid copolymer blend (EVOH/EAA) barrier coating on the layer and comprising ethylene vinyl alcohol copolymer (EVOH) and ethylene acrylic acid copolymer (EAA) at a weight ratio of EVOH to EAA of 1.5:1 to about 6:1, wherein the EAA has an acrylic acid content of 10 wt % to 35 wt %; and wherein the coated film has percent reduction in oxygen transmission rate (23° C., 50% relative humidity) of 80% or greater relative to a same film without the EVOH/EAA barrier coating. Optionally, the embodiment can further include one or more of the following: Element 1: wherein the EVOH/EAA barrier coating further comprises a crosslinker selected from the group consisting of urea formaldehyde, melamine formaldehyde, glyoxal, glutaraldehyde, zirconium oxide, zinc oxide, titanium lactate, and any combination thereof; Element 2: Element 1 and wherein the crosslinker is present at a weight ratio of EVOH to crosslinker of 1:0.01 to about 1:0.1; Element 3: wherein the EVOH/EAA barrier coating further comprises an adhesion promoter selected from the group consisting of polyethyleneimine, polyurethane, polyacrylic acid, and any combination thereof; Element 4: wherein the EVOH has a viscosity (20° C., 4% solids in water pH 7) of about 1 cps to about 35 cps; Element 5: wherein the EAA has a number average molecular weight of 2,000 g/mol to about 180,000 g/mol; Element 6: wherein the EAA has a neutralization degree of 40% to 70%; Element 7: wherein the EVOH/EAA barrier coating further comprises a particulate additive having an aspect ratio of 2 or greater; Element 8: wherein the EVOH/EAA barrier coating is less than 1 micron thick; Element 9: wherein the polymer layer comprises a polymer that is selected from the group consisting of polylactic acid (PLA), polyethylene terephthalate (PET), biaxially oriented polyethylene terephthalate (BOPET), oriented polypropylene (OPP), biaxially oriented polypropylene (BOPP), cast polypropylene (CPP), polyethylene (PE), polypropylene (PP), biaxially oriented polyamide (BOPA), and any combination thereof; Element 10: wherein the vacuum applied coating comprises one selected from the group consisting of aluminum, aluminum oxide, silicon oxide, silicon oxynitride, magnesium oxide, tin oxide, and any combination thereof; Element 11: wherein the primer coating comprises polyethyleneimine, polyurethane, or a mixture of polyurethane and EAA; Element 12: wherein the coated film has percent reduction in oxygen transmission rate (23° C., 0% relative humidity) of 50% or greater relative to the same film without the EVOH/EAA barrier coating; Element 13: wherein the coated film has percent reduction in oxygen transmission rate (23° C., 90% relative humidity) of 60% or greater relative to the same film without the EVOH/EAA barrier coating; Element 14: wherein the coated film has percent reduction in water vapor transmission rate (38° C., 90% relative humidity) of 10% or greater relative to the same film without the EVOH/EAA barrier coating; and Element 15: wherein the coated film has an absence of polyvinyl alcohol. Examples of combinations include, but are not limited to, Element 1 (and optionally Element 2) in combination with one or more of Elements 3-15; Element 3 in combination with one or more of Elements 4-15; Element 4 in combination with one or more of Elements 5-15; Element 5 in combination with one or more of Elements 6-15; Element 6 in combination with one or more of Elements 7-15; Element 7 in combination with one or more of Elements 8-15; Element 8 in combination with one or more of Elements 9-15; Element 9 in combination with one or more of Elements 10-15; Element 10 in combination with one or more of Elements 11-15; Element 11 in combination with one or more of Elements 12-15; Element 13 in combination with one or more of Elements 14-15; and Elements 14 and 15 in combination.

Another nonlimiting example embodiment is a method comprising: applying an ethylene vinyl alcohol copolymer/ethylene acrylic acid copolymer blend (EVOH/EAA) barrier coating mixture to a layer of a film, wherein the EVOH/EAA barrier coating mixture comprises ethylene vinyl alcohol copolymer (EVOH) and ethylene acrylic acid copolymer (EAA) at a weight ratio of EVOH to EAA of 1.5:1 to about 6:1, wherein the EAA has an acrylic acid content of 10 wt % to 35 wt %, and wherein the layer is selected from the group consisting of a polymer layer, vacuum applied coating, a printed layer, and a primer coating; and drying the EVOH/EAA barrier coating mixture to produce an EVOH/EAA barrier coating on the layer. Optionally, the embodiment can further include one or more of the following: Element 16: the method further comprising: corona treating the layer before applying the EVOH/EAA barrier coating mixture; Element 17: the method further comprising: applying a printed layer to the EVOH/EAA barrier coating; Element 18: the method further comprising: applying a vacuum applied coating to the EVOH/EAA barrier coating; Element 19: wherein the EVOH/EAA barrier coating mixture has an absence of polyvinyl alcohol; Element 20: wherein the EVOH/EAA barrier coating mixture further comprises a crosslinker selected from the group consisting of urea formaldehyde, melamine formaldehyde, glyoxal, glutaraldehyde, zirconium oxide, zinc oxide, titanium lactate, and any combination thereof; Element 21: wherein the crosslinker is present at a weight ratio of EVOH to crosslinker of 1:0.01 to about 1:0.1; Element 22: wherein the EVOH/EAA barrier coating mixture further comprises an adhesion promoter selected from the group consisting of polyethyleneimine, polyurethane, polyacrylic acid, and any combination thereof; Element 23: wherein the EVOH has a viscosity (20° C., 4% solids in water pH 7) of about 1 cps to about 35 cps; Element 24: wherein the EAA has a number average molecular weight of 2,000 g/mol to about 180,000 g/mol; Element 25: wherein the EAA has a neutralization degree of 40% to 70%; Element 26: wherein the EVOH/EAA barrier coating mixture further comprises a particulate additive having an aspect ratio of 2 or greater; Element 27: wherein the EVOH/EAA barrier coating is less than 1 micron thick; Element 28: wherein the polymer layer comprises a polymer is selected from the group consisting of polylactic acid (PLA), polyethylene terephthalate (PET), biaxially oriented polyethylene terephthalate (BOPET), oriented polypropylene (OPP), biaxially oriented polypropylene (BOPP), cast polypropylene (CPP), polyethylene (PE), polypropylene (PP), biaxially oriented polyamide (BOPA), and any combination thereof; Element 29: wherein the vacuum applied coating comprises one selected from the group consisting of aluminum, aluminum oxide, silicon oxide, silicon oxynitride, magnesium oxide, tin oxide, and any combination thereof; Element 30: wherein the coated film has percent reduction in oxygen transmission rate (23° C., 0% relative humidity) of 50% or greater relative to the same film without the EVOH/EAA barrier coating; Element 31: wherein the coated film has percent reduction in oxygen transmission rate (23° C., 90% relative humidity) of 60% or greater relative to the same film without the EVOH/EAA barrier coating; Element 32: wherein the coated film has percent reduction in water vapor transmission rate (38° C., 90% relative humidity) of 10% or greater relative to the same film without the EVOH/EAA barrier coating; and Element 33: wherein the coated film has an absence of polyvinyl alcohol. Examples of combinations include, but are not limited to, one of Elements 16-18 in combination with one or more of Elements 19-33; Element 19 in combination with one or more of Elements 20-33; Element 20 in combination with one or more of Elements 21-33; Element 21 in combination with one or more of Elements 22-33; Element 22 in combination with one or more of Elements 23-33; Element 23 in combination with one or more of Elements 24-33; Element 24 in combination with one or more of Elements 25-33; Element 25 in combination with one or more of Elements 26-33; Element 26 in combination with one or more of Elements 27-33; Element 27 in combination with one or more of Elements 28-33; Element 28 in combination with one or more of Elements 29-33; Element 29 in combination with one or more of Elements 30-33; Element 30 in combination with one or more of Elements 31-33; Element 31 in combination with one or more of Elements 32-33; and Elements 32 and 33 in combination.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

One or more illustrative embodiments incorporating the invention embodiments disclosed herein are presented herein. Not all features of a physical implementation are described or shown in this application for the sake of clarity. It is understood that in the development of a physical embodiment incorporating the embodiments of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

To facilitate a better understanding of the embodiments of the present invention, the following examples of preferred or representative embodiments are given. In no way should the following examples be read to limit, or to define, the scope of the invention.

### Examples

Three samples were produced using different EVOH polymers by dissolving at 4% solids in water. The viscosity of the mixtures (Table 1) was measured, where higher viscosity generally indicates a higher molecular weight polymer. This data is summarized in Table 1.

TABLE 1

| | Viscosity (cps) of 4% solution |
|---|---|
| EVOH Polymer | in water at 20° C. |
| EXCEVAL ™ AQ-4104 | 4.0 |
| EXCEVAL ™ HR-3010 | 14.0 |
| EXCEVAL ™ RS-2117 | 27.5 |

EXCEVAL ™ are water-soluble EVOH available from Kuraray America.

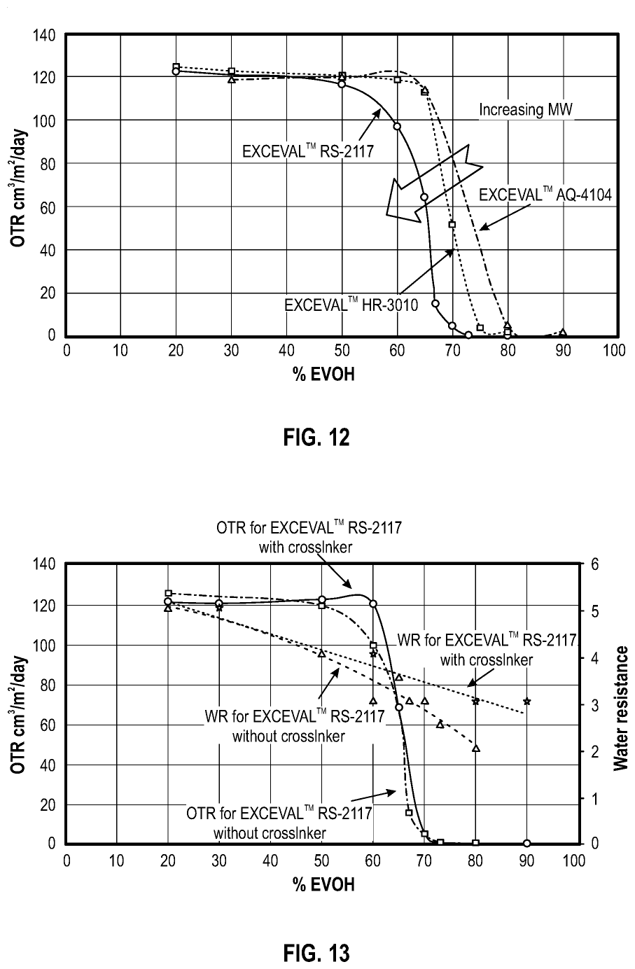

These samples were then blended with an EAA having an acrylic acid content of about 20 wt %, a molecular weight of about 100,000 g/mol, and a neutralization degree at about 67% at various ratios. The mixture was then coated onto either a BOPET film or a BOPET film with a vacuum deposited AlOx coating using a K-Lox hand coater and subsequently dried at 105° C. for 1 minute. The oxygen transmission rate of the film samples are plotted in FIG. 12. For each EVOH, there is a decrease in barrier properties as more EAA is included in the EVOH/EAA barrier coating. Further, the barrier properties are dependent on the molecular weight of the EVOH where higher molecular weights provide barrier properties with higher EAA concentrations in the EVOH/EAA barrier coating. That is, by increasing the molecular weight of the EVOH, higher EAA concentrations can be used to maintain a higher barrier. Because a higher EAA concentration is believed to increase the water resistance of the EVOH/EAA barrier coating, higher molecular weight EVOH may be preferred.

A plurality of films were produced using the high molecular weight EVOH (EXCEVAL™ RS-2117) and EAA (acrylic acid content of 20 wt %, molecular weight of 100,000 g/mol, and neutralization degree at 67%). The barrier properties and water resistance of these films are provided in Table 2. The water resistance was measured more than once and an average of the tests is reported in Table 2.

TABLE 2

| | | | | % OTR | % WVTR |
|---|---|---|---|---|---|
| Substrate | OTR | WVTR | WR | reduction | reduction |
| BOPET AlOx | 2.0 | 1.0 | n/a | n/a | n/a |
| EVOH/EAA wt % | | | | | |
| solid | | | | | |
| 20/80 EVOH/EAA | 1.28 | 0.65 | 5 | 36 | 35 |
| 50/50 EVOH/EAA | 1.1 | 0.52 | 5 | 45 | 48 |
| 60/40 EVOH/EAA | 0.68 | 0.39 | 4 | 66 | 61 |
| 65/35 EVOH/EAA | 0.18 | 0.34 | 3.5 | 91 | 66 |
| 67/33 EVOH/EAA | 0.06 | — | 3 | 97 | — |
| 70/30 EVOH/EAA | 0.04 | — | 3 | 98 | — |
| 73/27 EVOH/EAA | 0.02 | 0.63 | 3 | 99 | 37 |
| 80/20 EVOH/EAA | 0.02 | 0.63 | 2.5 | 99 | 37 |
| BOPET | 120 | 55 | n/a | n/a | n/a |
| EVOH/EAA wt % | | | | | |
| solid | | | | | |
| 20/80 EVOH/EAA | 123 | 43.4 | 5 | −2.5 | 21.1 |
| 50/50 EVOH/EAA | 117 | 39.2 | 4 | 2.5 | 28.7 |
| 60/40 EVOH/EAA | 97.5 | 35.4 | 3 | 18.8 | 35.6 |
| 65/35 EVOH/EAA | 64.5 | 37.2 | 3.5 | 46.3 | 32.4 |
| 67/33 EVOH/EAA | 15.3 | 36.3 | 3 | 87.3 | 34.0 |
| 70/30 EVOH/EAA | 4.96 | 34.3 | 3 | 95.9 | 37.6 |
| 73/27 EVOH/EAA | 0.76 | 32.7 | 2.5 | 99.4 | 40.5 |
| 80/20 EVOH/EAA | 0.4 | 31.4 | 2 | 99.7 | 42.9 |

— indicates that the values were not measured

A plurality of films were produced using the high molecular weight EVOH (EXCEVAL™ RS-2117), EAA (acrylic acid content of 20 wt %, molecular weight of 100,000 g/mol, and neutralization degree at 67%), and a glyoxal-based crosslinker (CARTABOND® TSI from Clariant). The barrier properties and water resistance of these films are provided in Table 3.

TABLE 3

| | | | % OTR |
|---|---|---|---|
| Substrate | OTR | WR | reduction |
| BOPET | 120 | n/a | n/a |
| EVOH/EAA wt % solid + | | | |
| crosslinker 1:0.1 on dry basis | | | |
| 20/80 EVOH/EAA | 119 | 5 | 0.8 |
| 30/70 EVOH/EAA | 118 | 5 | 1.7 |
| 50/50 EVOH/EAA | 120 | 4 | 0.0 |
| 60/40 EVOH/EAA | 118 | 4 | 1.7 |
| 65/35 EVOH/EAA | 67 | 3.5 | 44.2 |
| 70/30 EVOH/EAA | 5 | 3 | 95.8 |
| 80/20 EVOH/EAA | 0.4 | 3 | 99.7 |
| 90/10 EVOH/EAA | 0.16 | 3 | 99.9 |

The data in Tables 2 and 3 for coatings on BOPET are plotted in FIG. 13. The plot illustrates that decreasing the EAA wt % decreases the water resistance and increases the oxygen barrier properties. However, there are sweet spots where suitable water resistance (preferably 3 or greater) and suitable OTR (preferably less than 5 cc/(m²·day)).

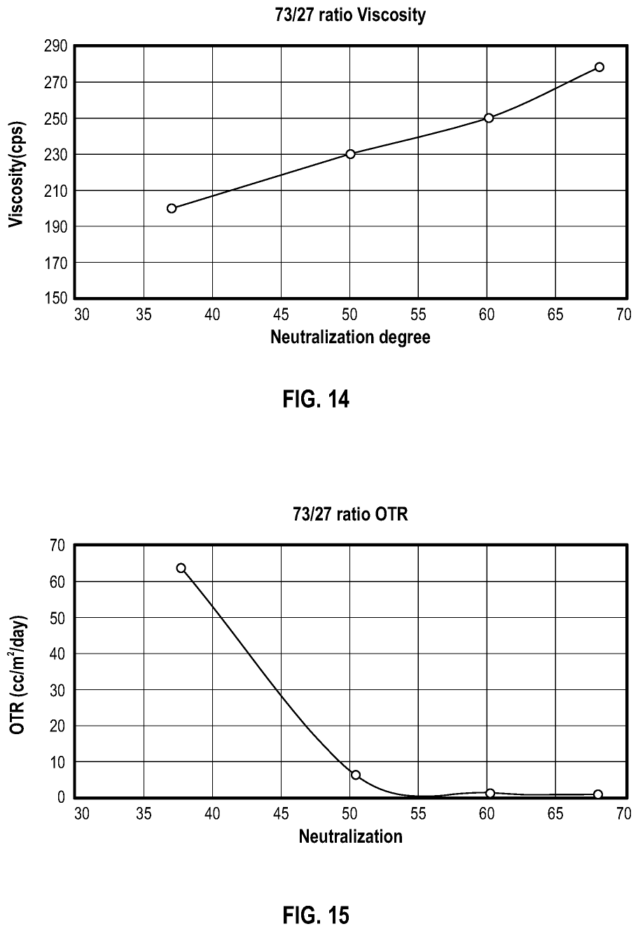

The effect of the degree of neutralization of the EAA was also investigated. EAA (acrylic acid content of 20 wt % and molecular weight of 100,000 g/mol) dispersions were prepared with varying degrees of neutralization. The dispersions were blended with EVOH (EXCEVAL™ RS-2117) at a blend ratio of 73 wt % EVOH to 27 wt % EAA. The viscosity and OTR of the samples are plotted in FIGS. 14 and 15, respectively. Increasing the degree of neutralization increases the viscosity of the mixture and improves the barrier properties.

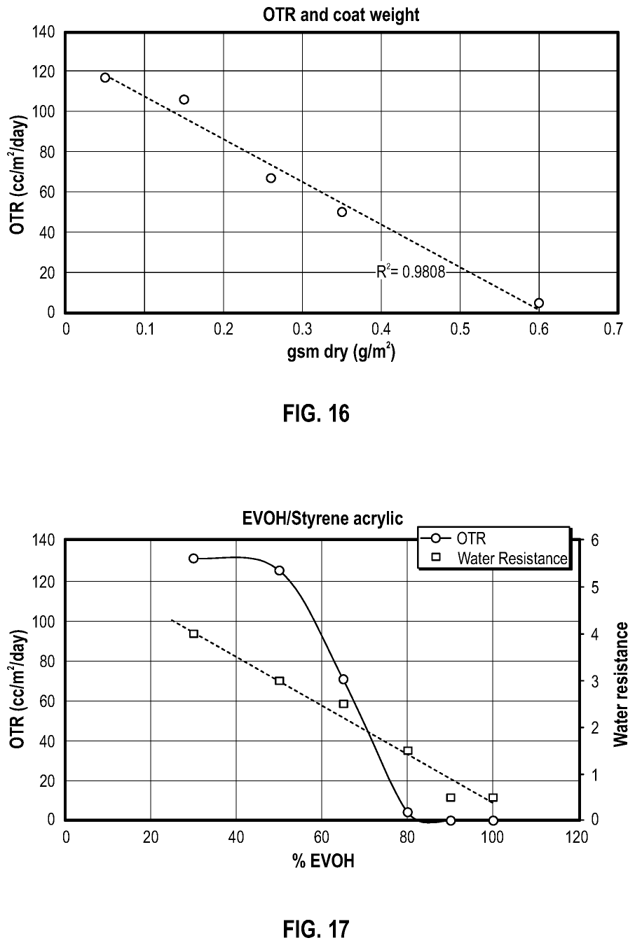

The effect of coat weight on OTR was investigated using a mixture of 4% solids being 73 wt % EVOH (EXCEVAL™ RS-2117) and 27 wt % EAA (acrylic acid content of 20 wt %, molecular weight of 100,000 g/mol, and neutralization degree at 67%) coated on a BOPET substrate. Table 4 and FIG. 16 provide the OTR as a function of dry coat weight. Generally, there is a linear decency of OTR on coating weight with higher coat weight providing better barrier properties.

TABLE 4

| Dry coat weight (g/m²) | OTR (cc/m²/day) |
|---|---|
| 0.05 | 117 |
| 0.15 | 106 |
| 0.26 | 67 |
| 0.35 | 50 |
| 0.6 | 4.58 |

A further sample was prepared using the previous mixture applied to a BOPP film. Table 5 provides the OTR and WVTR for the BOPP film and the coated BOPP film. The percent reduction in OTR and WVTR are similar to the percent reduction in OTR and WVTR using BOPET or AlOx/BOPET substrates (Table 2).

TABLE 5

| | OTR | WVTR | % OTR | % WVTR |
|---|---|---|---|---|
| Substrate | (cc/(m² · day)) | (g/m²/day) | reduction | reduction |
| BOPP film | 1000 | 5 | n/a | n/a |
| BOPP film with | 60 | 3 | 94 | 40 |
| 0.5 g/m² dry | | | | |
| weight | | | | |
| EVOH/EAA | | | | |
| coating | | | | |

Additional coated films were prepared with a polyethylene substrate (PE) and a polylactic acid (PLA) and a mixture of 5% solids being 78 wt % EVOH (EXCEVAL™ RS-2117) and 22 wt % EAA (acrylic acid content of 20 wt %, molecular weight of 100,000 g/mol, and neutralization degree at 55%) having a crosslinker therein at a EVOH/EAA:crosslinker weight ratio of 1:0.03 on dry basis. The dry coat weight was 0.8 g/m². Table 6 provides the OTR data, which illustrates that the EVOH/EAA barrier coatings described herein are useful on a plurality of substrates.

TABLE 6

| | OTR |
|---|---|
| Substrate | (cc/(m² · day)) |
| PE film | >1000 |
| PE film with EVOH/EAA coating | 24.4 |
| PLA film | 160 |
| PLA film with EVOH/EAA coating | 26 |

Additional coated films were prepared with a polyethylene terephthalate (PET) substrates and a mixture of 5% solids being 78 wt % EVOH (EXCEVAL™ RS-2117) and 22 wt % EAA (acrylic acid content of 20 wt %, molecular weight of 100,000 g/mol, and neutralization degree at 55%) having a crosslinker therein at a EVOH/EAA:crosslinker weight ratio of 1:0.03 on dry basis. The dry coat weight was 0.8 g/m². Table 7 provides the OTR and water resistance data, which illustrates that the EVOH/EAA barrier coatings described herein can be produced with different crosslinkers.

TABLE 7

| | OTR | |
|---|---|---|
| Substrate | (cc/(m² · day)) | WR |
| PET film | 120 | |
| PET film with EVOH/EAA coating | 9 | 3 |
| having CYMEL ™ (melamine- | | |
| formaldehyde crosslinker (amino | | |
| crosslinker, available from Allnex) | | |
| PET film with EVOH/EAA coating | 3.1 | 3.5 |
| having formaldehyde crosslinker | | |
| PET film with EVOH/EAA coating | 0.8 | 2.5 |
| having ZnO crosslinker | | |
| PET film with EVOH/EAA coating | 2.5 | 2.5 |
| having ZIRMEL ™1000 crosslinker | | |
| (zirconium crosslinker, available | | |
| from MEL Chemicals) | | |

Comparative coated films were prepared on PET substrates with barrier coating mixtures other than the EVOH/EAA combination. Specifically, EVOH/styrene acrylic (EVOH/SA), PVOH/EAA, and EVOH/EVA combinations were used. The dry coat weight was 0.8 g/m². Table 8 provides the OTR, visual appearance, water resistance, and formation stability (qualitative visual inspection for flocculation of wet mixture after 7 days) data for the different combinations.

TABLE 8

| Barrier Coating | | | | |
|---|---|---|---|---|
| Mixtures on | OTR | | Film | Formulation |
| PET Substrates | (cc/(m2 · day)) | WR | Appearance | Stability |
| EVOH/SA wt % | | | | |
| solid | | | | |
| 100/0 EVOH/SA | 0.1 | 0.5 | transparent | yes |
| 90/10 EVOH/SA | 0.22 | 0.5 | transparent | yes |
| 80/20 EVOH/SA | 4.38 | 1.5 | hazy | no |
| 65/35 EVOH/SA | 70.5 | 2.5 | hazy | no |
| 50/50 EVOH/SA | 125 | 3 | opaque | no |
| 30/70 EVOH/SA | 131 | 4 | opaque | no |
| 10/90 EVOH/SA | 130 | 5 | hazy | no |
| PVOH/EAA wt % | | | | |
| solid | | | | |
| 100/0 PVOH/EAA | 0.2 | 0 | transparent | medium |
| 80/20 PVOH/EAA | 0.88 | 0.5 | transparent | medium |
| 70/30 PVOH/EAA | 101 | 1 | transparent | medium |
| 65/35 PVOH/EAA | 113 | 1 | transparent | medium |
| 55/45 PVOH/EAA | 117 | 2.5 | transparent | medium |
| 40/60 PVOH/EAA | 116 | 3.5 | transparent | medium |
| 0/100 PVOH/EAA | 116 | 5 | transparent | medium |
| EVOH/EVA wt % | | | | |
| solid | | | | |
| 100/0 EVOH/EVA | 0.2 | 0.5 | slightly hazy | medium |
| 80/20 EVOH/EVA | 0.36 | 1.5 | hazy | no |
| 70/30 EVOH/EVA | 0.66 | 2 | hazy | no |
| 60/40 EVOH/EVA | 1.48 | 2.5 | hazy | no |
| 50/50 EVOH/EVA | 15.8 | 2.5 | hazy | no |
| 40/60 EVOH/EVA | 32.6 | 3 | hazy | no |
| 30/70 EVOH/EVA | 48 | 3.5 | hazy | no |
| 20/80 EVOH/EVA | 70 | 4 | hazy | no |
| 0/100 EVOH/EVA | 100 | 5 | transparent | yes |

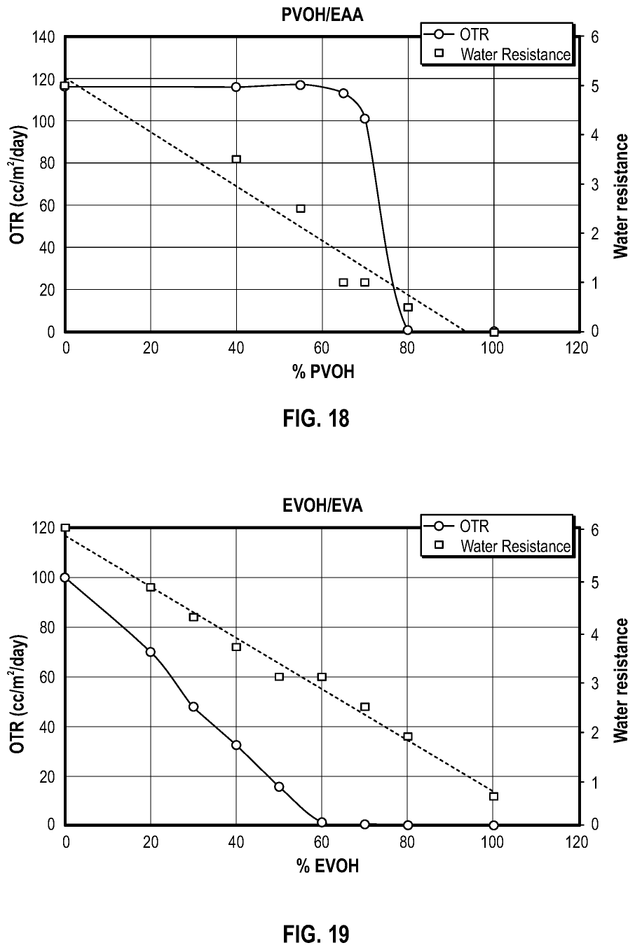

FIG. 17 is the OTR and water resistance data plotted from the EVOH/SA combination. FIG. 18 is the OTR and water resistance data plotted from the PVOH/EAA combination. FIG. 19 is the OTR and water resistance data plotted from the EVOH/EVA combination. For the EVOH/SA combination and the PVOH/EAA combination, lower barrier properties can be achieved but not in combination with a reasonable water resistance. For example, 90/10 EVOH/SA has a OTR of 0.22 cc/(m²·day) but a water resistance of 0.5; and 80/20 PVOH/EAA has a OTR of 0.88 cc/(m²·day) but a water resistance of 0.5. In contrast, 90/10 EVOH/EAA of the present disclosure has an OTR of 0.16 cc/(m²·day) and a water resistance of 3 (see Table 3).

Relative to the EVOH/EVA combination, the OTR can be improved while maintaining some water resistance but not to the extent of the EVOH/EAA of the present disclosure. However, the EVOH/EVA combination before coating is unstable and forms hazy films.

This example illustrates that the EVOH/EAA combination of the present disclosure synergistically produce barrier coatings with improved OTR while maintaining clarity and water resistance.

To improve the adhesion between the EVOH/EAA barrier coatings and the substrate, primers were tested. The coating was a mixture of 5% solids being 78 wt % EVOH (EXCEVAL™ RS-2117) and 22 wt % EAA (acrylic acid content of 20 wt %, molecular weight of 100,000 g/mol, and neutralization degree at 55%) having a polyethyleneimine crosslinker therein at a EVOH/EAA:crosslinker weight ratio of 1:0.03 on dry basis. The substrate was BOPP. The substrate was first coated with the primer and then the EVOH/EAA mixture. The dry coat weight was 0.8 g/m² for the EVOH/EAA barrier coating. Table 9 includes the qualitative observations regarding wetting and adhesion between the primed BOPP film and the EVOH/EAA barrier coating. For the wetting, a good film formed with very few to no visible defects like holes or fisheyes is considered a yes where with increasing defects the wetting as characterized as ok, medium, bad, and no. For the adhesion, a 100 value refers to all of the coating staying on the substrate after a tape test (application of and then removal of tape), and a 0 value refers to none of the coating on the substrate after a tape test.

TABLE 9

| Substrate | Wetting | Adhesion |
|---|---|---|
| BOPP film + MICHEM ™ FLEX P2300 | no | 100 |
| primer (aqueous-based | | |
| polyethyleneimine primer, available | | |
| from Michelman) + EVOH/EAA | | |
| coating | | |
| BOPP film + ESACOTE ™ DP46 | yes | 100 |
| primer (polyurethane dispersion, | | |
| available from Lamberti) + | | |
| EVOH/EAA coating | | |
| BOPP film + NEOREZ ™ 605 primer | yes | 100 |
| (polyurethane dispersion, available | | |
| from DSM NeoResins) + EVOH/EAA | | |
| coating | | |
| BOPP film + MICHEM ™ FLEX | yes | 0 |
| P1953R primer (aqueous-based | | |
| EAA/polyurethane primer, available | | |
| from Michelman) + EVOH/EAA | | |
| coating | | |

In some instances, an overcoat layer to the barrier coating is desired. Several samples were prepared by coating onto a substrate per Table 10 a mixture of 5% solids being 78 wt % EVOH (EXCEVAL™ RS-2117) and 22 wt % EAA (acrylic acid content of 20 wt %, molecular weight of 100,000 g/mol, and neutralization degree at 55%) having a polyethyleneimine crosslinker therein at a EVOH/EAA:crosslinker weight ratio of 1:0.03 on dry basis. The dry coat weight was 0.8 g/m² for the EVOH/EAA barrier coating. Then, aqueous-based overcoat layers were applied per Table 10. The overcoat layers had a dry coat weight of 0.8 g/m². The properties of the samples are provided in Table 10.

TABLE 10

| | OTR | | | |
|---|---|---|---|---|
| | (cc/(m² · | | | Adhe- |
| Substrate | day)) | WR | Wetting | sion |
| BOPP film/ESACOTE ™ DP46 | — | 5 | bad | 100 |
| primer + EVOH/EAA coating + | | | | |
| MICHEM ™ PRIME 4983 | | | | |
| (aqueous ethylene acrylic, | | | | |
| available from Michelman) | | | | |
| BOPP film/ESACOTE ™ DP46 | — | 5 | medium | 100 |
| primer + EVOH/EAA coating + | | | | |
| NEOCRYL ™ A2092 | | | | |
| (acrylic copolymer | | | | |
| dispersion, available from | | | | |
| DSM NeoResins) | | | | |
| BOPP film/ESACOTE ™ DP46 | — | 5 | medium | 100 |
| primer + EVOH/EAA coating + | | | | |
| TEX ™ 13820 (styrene | | | | |
| acrylics, available from | | | | |
| Scott Bader) | | | | |
| BOPP film/ESACOTE ™ DP46 | — | 5 | no | 100 |
| primer + EVOH/EAA coating + | | | | |
| SYTRONAL ™ ND656 | | | | |
| (styrene-butadiene binder, | | | | |
| available from BASF) | | | | |
| PET (no primer) + | 0.8 | 5 | ok | 0 |
| EVOH/EAA coating + | | | | |
| MICHEM ™ PRIME 4983 | | | | |
| PET (no primer) + | 0.6 | 5 | ok | 0 |
| EVOH/EAA coating + | | | | |
| NEOCRYL ™ A2092 | | | | |
| PET (no primer) + | 0.2 | 5 | ok | 0 |
| EVOH/EAA coating + JON ™ | | | | |
| 1674 (styrene acrylic, | | | | |
| available from BASF) | | | | |
| PET (no primer) + | 1.3 | 5 | ok | 0 |
| EVOH/EAA coating + TEX ™ | | | | |
| 13820 | | | | |
| PET (no primer) + | — | — | no | — |
| EVOH/EAA coating + | | | | |
| EASTEX ™ 1200 | | | | |
| (sulfopolyester aqueous | | | | |
| dispersion, available from | | | | |
| Eastman) | | | | |

In each example of Table 10, the film appearance (or transparency) was retained when the aqueous-based overcoat layer was applied. In contrast, 100% EVOH coatings haze or become gummy when an aqueous-based overcoat layer is applied. A crosslinked EVOH coat may stay transparent but is not stable over time. The inclusion of EAA herein has improved the properties of the barrier coating.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

1. A coated film comprising:
a film comprising a layer selected from the group consisting of a polymer layer, vacuum applied coating, a printed layer, and a primer coating;
an ethylene vinyl alcohol copolymer/ethylene acrylic acid copolymer blend (EVOH/EAA) barrier coating on the layer and comprising ethylene vinyl alcohol copolymer (EVOH) and ethylene acrylic acid copolymer (EAA) at a weight ratio of EVOH to EAA of 1.5:1 to about 6:1, wherein the EAA has an acrylic acid content of 10 wt % to 35 wt %; and
wherein the coated film has percent reduction in oxygen transmission rate (23° C., 50% relative humidity) of 80% or greater relative to a same film without the EVOH/EAA barrier coating.

2. The coated film of claim 1, wherein the EVOH/EAA barrier coating further comprises a crosslinker selected from the group consisting of urea formaldehyde, melamine formaldehyde, glyoxal, glutaraldehyde, zirconium oxide, zinc oxide, titanium lactate, and any combination thereof.

3. The coated film of claim 2, wherein the crosslinker is present at a weight ratio of EVOH to crosslinker of 1:0.01 to about 1:0.1.

4. The coated film of claim 1, wherein the EVOH/EAA barrier coating further comprises an adhesion promoter selected from the group consisting of polyethyleneimine, polyurethane, polyacrylic acid, and any combination thereof.

5. The coated film of claim 1, wherein the EVOH has a viscosity (20° C., 4% solids in water pH 7) of about 1 cps to about 35 cps.

6. The coated film of claim 1, wherein the EAA has a number average molecular weight of 2,000 g/mol to about 180,000 g/mol.

7. The coated film of claim 1, wherein the EAA has a neutralization degree of 40% to 70%.

8. The coated film of claim 1, wherein the EVOH/EAA barrier coating further comprises a particulate additive having an aspect ratio of 2 or greater.

9. The coated film of claim 1, wherein the EVOH/EAA barrier coating is less than 1 micron thick.

10. The coated film of claim 1, wherein the polymer layer comprises a polymer is selected from the group consisting of polylactic acid (PLA), polyethylene terephthalate (PET), biaxially oriented polyethylene terephthalate (BOPET), oriented polypropylene (OPP), biaxially oriented polypropylene (BOPP), cast polypropylene (CPP), polyethylene (PE), polypropylene (PP), biaxially oriented polyamide (BOPA), and any combination thereof.

11. The coated film of claim 1, wherein the vacuum applied coating comprises one selected from the group consisting of aluminum, aluminum oxide, silicon oxide, silicon oxynitride, magnesium oxide, tin oxide, and any combination thereof.

12. The coated film of claim 1, wherein the primer coating comprises polyethyleneimine, polyurethane, or a mixture of polyurethane and EAA.

13. The coated film of claim 1, wherein the coated film has percent reduction in oxygen transmission rate (23° C., 0% relative humidity) of 50% or greater relative to the same film without the EVOH/EAA barrier coating.

14. The coated film of claim 1, wherein the coated film has percent reduction in oxygen transmission rate (23° C., 90% relative humidity) of 60% or greater relative to the same film without the EVOH/EAA barrier coating.

15. The coated film of claim 1, wherein the coated film has percent reduction in water vapor transmission rate (38° C., 90% relative humidity) of 10% or greater relative to the same film without the EVOH/EAA barrier coating.

16. The coated film of claim 1, wherein the coated film has an absence of polyvinyl alcohol.

17. A method comprising:
applying an ethylene vinyl alcohol copolymer/ethylene acrylic acid copolymer blend (EVOH/EAA) barrier coating mixture to a layer of a film, wherein the EVOH/EAA barrier coating mixture comprises ethylene vinyl alcohol copolymer (EVOH) and ethylene acrylic acid copolymer (EAA) at a weight ratio of EVOH to EAA of 1.5:1 to about 6:1, wherein the EAA has an acrylic acid content of 10 wt % to 35 wt %, and wherein the layer is selected from the group consisting of a polymer layer, vacuum applied coating, a printed layer, and a primer coating; and
drying the EVOH/EAA barrier coating mixture to produce an EVOH/EAA barrier coating on the layer.

18. The method of claim 17 further comprising one or more of the following further steps:
corona treating the layer before applying the EVOH/EAA barrier coating mixture
applying a printed layer to the EVOH/EAA barrier coating, or
applying a vacuum applied coating to the EVOH/EAA barrier coating.

19. (canceled)

20. (canceled)

21. The method film of claim 17, wherein the EVOH/EAA barrier coating mixture further comprises a crosslinker selected from the group consisting of urea formaldehyde, melamine formaldehyde, glyoxal, glutaraldehyde, zirconium oxide, zinc oxide, titanium lactate, and any combination thereof.

22.-34. (canceled)

35. The method film of claim 17, wherein the coated film has an absence of polyvinyl alcohol.
